(19) United States
(12) Patent Application Publication
(10) Pub. No.: US 2021/0341095 A1
(43) Pub. Date: Nov. 4, 2021

(54) Simple Kickstand for Electronic Devices

(71) Applicant: DONGGUAN SUNWAY PRECISION TECHNOLOGY CO.LTD, Dongguan (CN)

(72) Inventor: Xinghua Long, Anlong (CN)

(73) Assignee: DONGGUAN SUNWAY PRECISION TECHNOLOGY CO.LTD

(21) Appl. No.: 17/377,417

(22) Filed: Jul. 16, 2021

(51) Int. Cl. F16M 13/00

(52) U.S. Cl. CPC F16M 13/005

(57) ABSTRACT

A simple kickstand for electronic devices comprises a base plate, a support plate, and a hinge pin. The base plate and the support plate are located at the same end and are provided with lugs. Pin cavities are formed in the lugs of the base plate and the support plate. One pair of symmetrical end faces of the hinge pin are arc faces, and the other pair of symmetrical end faces of the hinge pin are planes. The hinge pin sequentially penetrates into the pin cavities of the support plate and the base plate, and inner wall faces of the pin cavities fit the end faces of the hinge pin.

### BACKGROUND OF THE INVENTION

### 1. Technical Field

The invention relates to the technical field of accessories of mobile phone shells and tablet personal computers, in particular to a simple kickstand for electronic devices.

### 2. Description of Related Art

As is commonly known, electronic devices such as mobile phones and tablet personal computers have become common products in people's daily life with the continuous development of science and technology. Users use mobile phones or tablet personal computers generally by holding them by hand, and may feel fatigue after holding the heavy electronic devices for a long time. To allow users to use electronic devices for a long time without feeling tired, corresponding kickstands are used to support the electronic devices at a proper angle.

At present, there are two types of kickstands: external kickstands and kickstands integrated on the shell of electronic devices. When the external kickstand is used, an electronic device is directly placed on the external kickstand to be supported by the kickstand; however, such a kickstand has to be carried by users all the time. Compared with the external kickstand, the kickstand integrated on the shell of electronic devices does not need to be separately carried by users and can be used to support electronic devices at any time, thus being popular with most users.

However, existing integrated kickstands are designed as follows: a receiving groove is formed in the shell of electronic devices, and the kickstand is hinged to the receiving groove as a single piece, so a corresponding hinge port has to be formed in the receiving groove of the electronic devices, which inevitably increases the machining costs and manufacturing difficulties. In addition, the existing kickstands are provided with a damping shaft, for which a hinge gasket has to be additionally disposed on a plate of the kickstands to ensure the connecting stability, thus increasing the thickness of the plate of the kickstands and increasing the depth of the receiving groove, bringing difficulties to the overall design because the thickness of the shell of the electronic devices is limited.

### BRIEF SUMMARY OF THE INVENTION

The objective of the invention is to overcome the defects of the prior art by providing a simple kickstand for electronic devices.

To fulfill the above objective, the invention adopts the following technical solution:

A simple kickstand for electronic devices comprises a base plate, a support plate, and a hinge pin, wherein the base plate and the support plate are located at the same end and are provided with lugs, pin cavities are formed in the lugs of the base plate and the support plate, one pair of symmetrical end faces of the hinge pin are arc faces, the other pair of symmetrical end faces of the hinge pin are planes, the hinge pin sequentially penetrates into the pin cavities of the support plate and the base plate, inner wall faces of the shaft cavities fit the end faces of the hinge pin, and the base plate is detachably assembled on a back shell of an electronic device.

Preferably, a back side of the base plate is coated with a 3M adhesive, and the base plate is attached to the back shell of the electronic device with the 3M adhesive.

Preferably, the base plate is provided with at least one lug, the support plate is provided with at least two lugs, and the lug of the base plate is disposed between the lugs of the support plates.

Preferably, an arc notch is formed in an end, opposite to the lugs, of the support plate.

Preferably, the base plate and the support plate are both metal plates, and the hinge pin is a metal hinge pin.

Preferably, electroplated coatings are disposed on surfaces of the base plate and the support plate.

Preferably, an electroplating suspension hole is formed in the base plate or the support plate.

Preferably, conical heads are disposed at two ends of the hinge pin.

By adoption of the above solution, the base plate and the support plate constitute the kickstand, and the base plate is used as a component hinged and connected to the support plate, such that it is no longer necessary to dispose a corresponding hinge part on the shell of the electronic device. The arc faces and planes of the hinge pin fit the inner wall faces of the pin cavities, so that a damping effect can be realized during the rotating process, and the base plate and the support plate can be restored instantly or be unfolded at a fixed angle after being rotated to a certain angle, and can be self-locked after being restored. In addition, through the combination of the pin cavities formed in the self-locked lugs, and the hinge pin, hinge gaskets can be eliminated, such that the thickness of the base plate and the support plate is greatly decreased in design.

### BRIEF DESCRIPTION OF THE SEVERAL VIEWS OF THE DRAWINGS

FIG. 1 is a structural principle diagram according to one embodiment of the invention.

FIG. 2 is a structural diagram of shaft cavities according to one embodiment of the invention.

FIG. 3 is a structural diagram in a folded state according to one embodiment of the invention.

FIG. 4 and FIG. 5 are structural diagrams of lugs formed by curling according to one embodiment of the invention.

### DETAILED DESCRIPTION OF THE INVENTION

The embodiments of the invention will be described in detail below in conjunction with the accompanying drawings. Obviously, the invention may be implemented in different manners defined and covered by the claims.

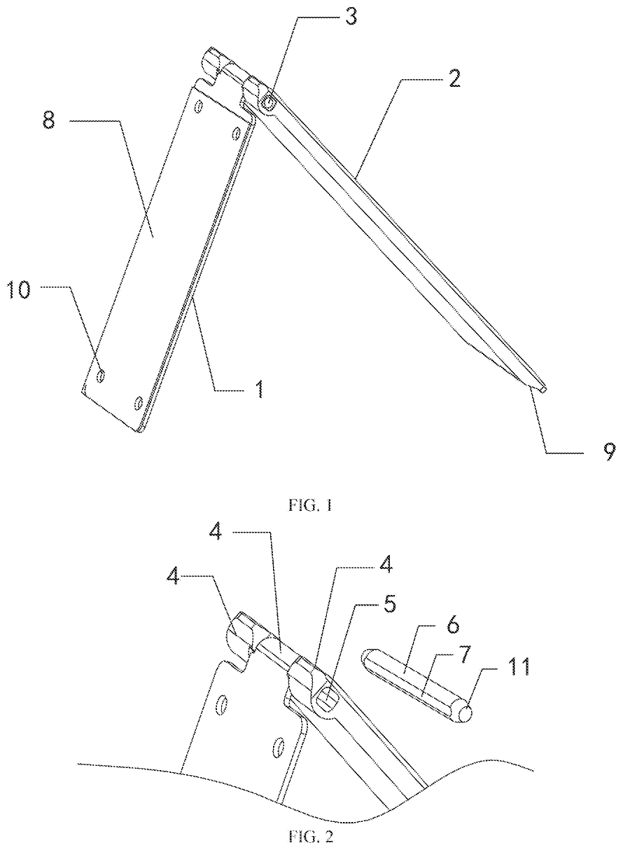

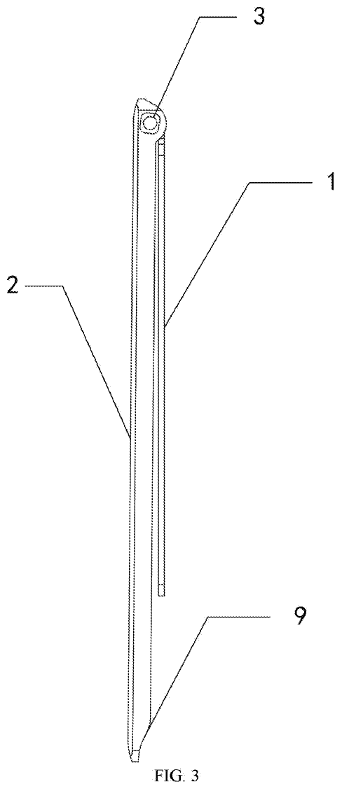

As shown in FIG. 1 to FIG. 5, this embodiment provides a simple kickstand for electronic devices. The simple kickstand for electronic devices comprises a base plate 1, a support plate 2, and a hinge pin 3, wherein the base plate 1 and the support plate 2 are located at the same end and are provided with lugs 4, pin cavities 5 are formed in the lugs 4 of the base plate 1 and the support plate 2, one pair of symmetrical end faces of the hinge pin 3 are arc faces 6, the other pair of symmetrical end faces of the hinge pin 3 are planes 7, the hinge pin 3 sequentially penetrates into the pin cavities 5 of the support plate 2 and the base plate 1, inner wall faces of the pin cavities 5 fit the end faces of the hinge pin 3, and the base plate 1 is detachably assembled on a back shell of an electronic device.

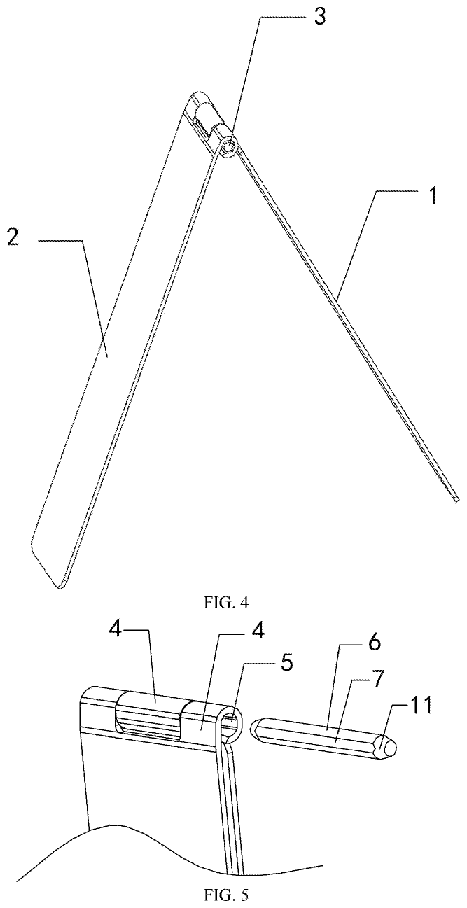

In this embodiment, the base plate 1 and the support plate 2 constitute the kickstand, and the base plate 1 is used as a component hinged and connected to the support plate 2, so that it is no longer necessary to dispose a corresponding hinge part on the shell of the electronic device. When the simple kickstand is used, the base plate 1 is assembled on the back shell of the electronic device, and the support plate 2 is used as a support bar. When the simple kickstand is not used, the support plate 2 and the base plate 1 are folded together; and when used to support the electronic device, the support plate 2 is unfolded. The base plate 1 and the support plate 2 are unfolded or unfolded by rotation. In this embodiment, corresponding structures are designed to realize the rotation of the base plate 1 and the support plate 2. Specifically, the lugs 4 are formed on the base plate 1 and the support plate 2, the pin cavities 5 are formed in the lugs 4, and the hinge pin 3 penetrates into the pin cavities 5. When clamped in the pin cavities 5, the hinge pin 3 will be elastically squeezed by the pin cavities 5, a damping effect is realized by the clamping force of the pin cavities 5 to the hinge pin 3, and the base plate 1 and the support plate 2 are able to rotate under the elastic force. In addition, the arc faces 6 and planes 7 of the hinge pin 3 fit the inner wall faces of the pin cavities 5, such that the angle can be fixed during the rotating process, that is, a damping effect is realized. When the base plate 1 and the support plate 2 need to be restored after being rotating to be staggered with each other, the base plate 1 and the support plate 2 can be restored instantly by means of the elastic force of the pin cavities 5, and can be self-locked after being restored. Moreover, the lugs 4 and pin cavities 5 in this embodiment may also be formed by curling, and the specific structure is shown in FIG. 4 and FIG. 5.

Further, in this embodiment, to detachably assemble the base plate 1 on the back shell of the electronic device, the back side of the base plate 1 is coated with a 3M adhesive, and the base plate 1 is attached to the back shell of the electronic device with the 3M adhesive. In this way, the base plate 1 can be assembled on the back shell of the electronic device in an attached manner and can be detached from the back shell of the electronic device.

Further, in this embodiment, the base plate 1 is provided with at least one lug 4, the support plate 2 is provided with at least two lugs 4, and the lug 4 of the base plate 1 is disposed between the lugs 4 of the support plate 2.

Further, in this embodiment, an arc notch 9 is formed in an end, opposite to the lugs 4, of the support plate 2. Through the design of the arc notch 9, users can stretch their finger into the notch 9 to apply force to pull up the support plate 2 when the support plate 2 needs to be unfolded.

Further, in this embodiment, the base plate 1 and the support plate 2 are both metal plates, and the hinge pin 3 is a metal hinge pin. Electroplated coatings are disposed on surfaces of the base plate 1 and the support plate 2. Through the design of the electroplated coatings, the texture of the base plate 1 and the support plate 2 are improved. To suspend the base plate 1 and the support plate 2 during electroplating, an electroplating suspension hole 10 is formed in the base plate 1 or the support plate 2.

Further, to insert the hinge pin 3 into the pin cavities 5, conical heads 11 are disposed at two ends of the hinge pin 3 in this embodiment. The conical heads 11 fulfill a guide effect when the hinge pin 3 is inserted into the pin cavities 5.

The above embodiments are merely preferred ones of the invention, and are not intended to limit the scope of the patent of invention. All equivalent structural transformations or flow transformations made based on the contents of the specification and drawings of the invention, or direct or indirect applications to other relating technical fields should also fall within the protection scope of the patent of invention.

What is claimed is:

1. A simple kickstand for electronic devices, comprising a base plate, a support plate, and a hinge pin, wherein the base plate and the support plate are located at a same end and are provided with lugs, pin cavities are formed in the lugs of the base plate and the support plate, one pair of symmetrical end faces of the hinge pin are arc faces, another pair of symmetrical end faces of the hinge pin are planes, the hinge pin sequentially penetrates into the pin cavities of the support plate and the base plate, inner wall faces of the shaft cavities fit the end faces of the hinge pin, and the base plate is detachably assembled on a back shell of an electronic device.

2. The simple kickstand for electronic devices according to claim 1, wherein a back side of the base plate is coated with a 3M adhesive, and the base plate is attached to the back shell of the electronic device with the 3M adhesive.

3. The simple kickstand for electronic devices according to claim 2, wherein the base plate is provided with at least one lug, the support plate is provided with at least two lugs, and the lug of the base plate is disposed between the lugs of the support plates.

4. The simple kickstand for electronic devices according to claim 1, wherein an arc notch is formed in an end, opposite to the lugs, of the support plate.

5. The simple kickstand for electronic devices according to claim 1, wherein the base plate and the support plate are both metal plates, and the hinge pin is a metal hinge pin.

6. The simple kickstand for electronic devices according to claim 5, wherein electroplated coatings are disposed on surfaces of the base plate and the support plate.

7. The simple kickstand for electronic devices according to claim 6, wherein an electroplating suspension hole is formed in the base plate or the support plate.

8. The simple kickstand for electronic devices according to claim 1, wherein conical heads are disposed at two ends of the hinge pin.
